(19) United States
(12) Patent Application Publication
(10) Pub. No.: US 2005/0200709 A1
(43) Pub. Date: Sep. 15, 2005

(54) Composition photographing apparatus and sound recording method using the same

(75) Inventor: Yong-Hyun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/062,697

(22) Filed: Feb. 23, 2005

(30) Foreign Application Priority Data
Mar. 10, 2004 (KR) 2004-16048

(51) Int. Cl. H04N 5/225

(52) U.S. Cl. 348/207.99

(57) ABSTRACT

Disclosed is a composition photographing apparatus and a sound recording method using the same. The Digital Still Camera (DSC) and Digital Video Camera (DVC) composition photographing apparatus has a multiplexer (MUX) connected to the DSC and the DVC, respectively, that multiplexes moving image signals received from the DSC and the DVC, respectively. An Audio coder decoder (CODEC) codes the electric signals and combines the coded electric signals with the moving image signals multiplexed by the MUX. A control unit controls the multiplexing process of the MUX.

### CROSS-REFERENCE TO RELATED APPLICATIONS

This application claims the benefit under 35 U.S.C. §119(a) of Korean Patent Application No. 2004-16048, filed on Mar. 10, 2004, in the Korean Intellectual Property Office, the entire disclosure of which is hereby incorporated by reference.

### BACKGROUND OF THE INVENTION

1. Field of the Invention

The present invention relates in general to a composition photographing apparatus and a sound recording method using the same. More particularly, the present invention relates to a Digital Still Camera (DSC) and Digital Video Camera (DVC) composition photographing apparatus and a sound recording method for recording sound with photographed moving images.

2. Description of the Related Art

In general, a digital still camera (DSC) coverts an image received through a lens into a digital signal and stores the digital signal on a recording medium such as a hard disk or a memory card. That is, photographed images are not recorded on film but are converted into digital signals first and then are recorded on the recording medium such as a hard disk or a memory card. Therefore, the images stored in the recording medium can be transferred directly to digital equipment, such as a personal computer or the like, without undergoing digital conversion by a scanner. In particular, the digital still camera (DSC), which is highly compatible with PCs, so that any one can easily edit and modify the image. Also, the DSC has the same structure as a conventional camera so it is easy to carry around. The DSC includes a lens, a memory unit, a signal modulation unit, and a display, and due to the small capacity recording medium thereof, it is mainly used for photographing still images. In other words, although the DSC is capable of photographing moving images within a limited amount of time, it cannot photograph them for an extended period of time. To resolve these problems, a recording and reproducing device, such as a digital video camera (DVC), that is capable of recording the moving image and sound of a subject in a recording medium like a magnetic tape or a hard disk, and reproducing the recorded moving image, is broadly used.

The DVC includes a lens, a signal conversion unit, a deck for recording and reproducing photographed moving images, and a display. Also, the DVC includes a microphone and a speaker and is capable of recording moving images in the recording medium longer than one hour. Of course, the DVC can be used for photographing still images. However, since the picture quality thereof is relatively poorer than that of the DSC, the DVC is mainly used for photographing moving images. And, compared to the DSC, the DVC is more complicated in its structure and functions and thus, is generally bulky and expensive.

Until lately customers had to purchase a both DSC and a DVC in order to benefit from the advantages of each, but that is very uneconomical. In addition, having to carry two products together and learn how to operate two cameras further inconveniences the customer.

In an attempt to solve the above problems, there has been developed a DSC/DVC combination system, where the DSC and the DVC are combined in one case. This is also called a ‘digital camera/camcorder’, a composition photographing apparatus, or simply a ‘DuoCam’.

When a user photographs a moving image through the DVC of the composition photographing apparatus, conforming to the Digital Video standard, transmits 30 frames per second and synchronizes an audio signal to 32 kHz, 48 kHz, or 44.1 kHz. On the other hand, when the user photographs a moving image through the DSC of the composition photographing apparatus, although there is no specific standard for the DSC, the audio signal is generally synchronized to 8 kHz in consideration with of the amount of data to be transmitted.

Since the DVC and the DSC of the composition photographing apparatus uses different frequencies for the audio signal, an Audio CODEC is required in response to the DVC and the DSC, respectively. This only increases the cost of manufacturing the apparatus and the size of the composition photographing apparatus.

### SUMMARY OF THE INVENTION

Accordingly, it is a primary object of the present invention to provide a composition photographing apparatus and a sound recording method using the same, that is synchronizable with a DVC as well as a DSC by implementing an integrated Audio CODEC.

In order to achieve the above-described objects of the present invention, there is provided a Digital Still Camera (DSC) and Digital Video Camera (DVC) composition photographing apparatus, which includes a multiplexer (MUX) connected to the DSC and the DVC, respectively, and for multiplexing moving image signals received from the DSC and the DVC, respectively; an Audio CODEC for coding audio signals and combining the coded audio signals with the moving image signals multiplexed by the MUX; and a control unit for controlling the multiplexing process of the MUX.

Preferably, the composition photographing apparatus further comprises a microphone for receiving surrounding sounds and converting the sounds into electric audio signals.

Preferably, the DSC and the DVC, respectively, output a master clock (CLK) for synchronization with the Audio CODEC, and the Audio CODEC samples the coded audio signals based on the master CLK received through the MUX and combines the audio signal samples with the multiplexed moving image signals.

Preferably, the Audio CODEC samples the coded audio signals within a frequency range of 8 kHz to 60 kHz.

In addition, there is provided a sound recording method of a DSC and DVC composition photographing apparatus, the method comprising the steps of receiving surrounding sounds and converting the sounds into electric audio signals; multiplexing moving image signals received from the DSC and the DVC, respectively; coding the converted audio signals; and sampling the coded audio signals and combining the audio signal samples with the multiplexed moving image signals.

Preferably, the sound recording method further comprises the step of outputting a master CLK for the synchronization with an Audio CODEC in the DSC and the DVC, wherein the Audio CODEC samples the coded audio signals based on the master CLK and combines the audio signal samples with the multiplexed moving image signals.

Therefore, the composition photographing apparatus of the invention using an integrated Audio CODEC can more effectively combine audio signals with moving image signals received from the DVC or the DSC.

### BRIEF DESCRIPTION OF THE DRAWINGS

A more complete understanding of the embodiments of the invention, and many of the attendant advantages thereof, will be readily apparent by reference to the following description when considered in conjunction with the accompanying drawings in which like reference symbols indicate the same or similar components, wherein:

FIG. 1 is a schematic block diagram of a composition photographing apparatus according to an embodiment of the present invention;

FIG. 2 is a diagram for explaining an audio unit of FIG. 1; and

FIG. 3 is a flow chart describing a sound recording method of FIG. 2.

### DETAILED DESCRIPTION OF EXEMPLARY EMBODIMENTS

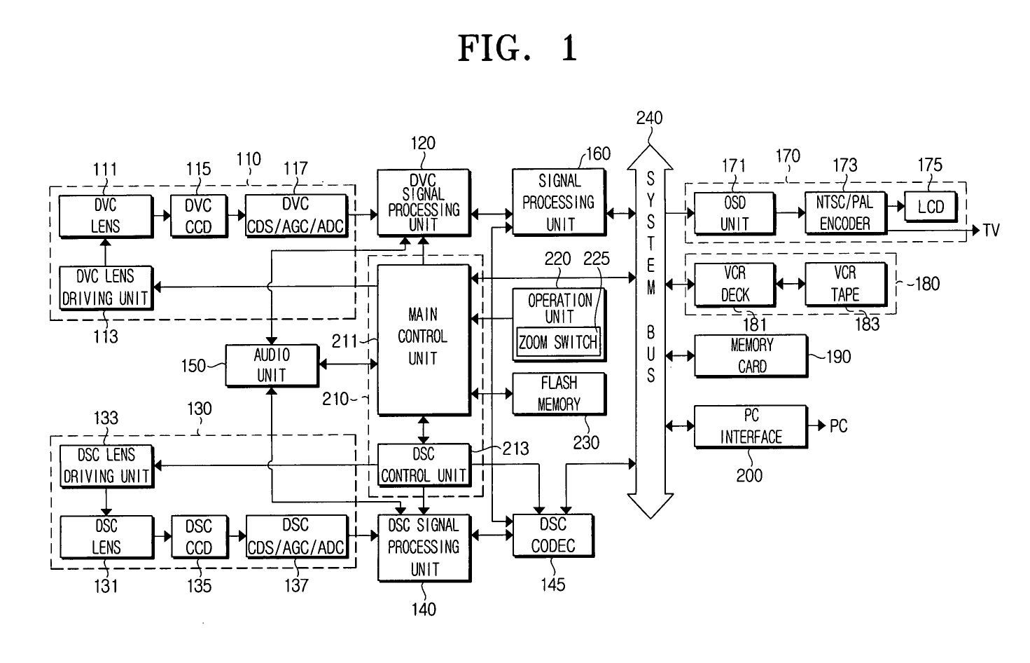

A composition photographing apparatus in accordance with embodiments of the present invention will now be described in detail with reference to the accompanying drawings. Referring to FIG. 1, the composition photographing apparatus comprises a Digital Video Camera (DVC) photographing block 110, a DVC signal processing unit 120, a Digital Still Camera (DSC) photographing block 130, a DSC signal processing unit 140, DSC COrder/DECoder (CODEC) 145, an audio unit 150, a signal processing unit 160, a display block 170, a Video Cassette Recorder (VCR) block 180, a memory card 190, PC interface 200, a control block 210, an operation unit 220, a flash memory 230, and a system bus 240.

The DVC photographing block 110 photoelectrically converts an optical signal passing through a lens into an electric signal, and executes a designated signal processing procedure on the converted signal. The DVC photographing block 110 is capable of photographing both moving images and still images. However, the picture quality of the still images photographed by the DVC photographing block 110 is poorer than that of the still images photographed by the DSC photographing block 130. Therefore, the DVC photographing block is used mainly for photographing moving images.

The DVC photographing block 110 comprises a DVC lens 111, a DVC lens driving unit 113, a DVC Charge Coupled Device (CCD) 115, and a DVC Correlated Double Sampler/Auto Gain Controller/Analog-to-Digital Converter (CDS/AGC/ADC) 117.

The DVC lens driving unit 113 drives the DVC lens 111 under the control of the control block 210. More specifically, the lens driving unit 113 zooms in/zooms out the DVC lens 111, automatically adjusts the focus, and adjusts an aperture size of a diaphragm (not shown) of the DVC lens 111.

The DVC CCD 115 converts an optical image passing through the DVC lens 111 to an electric signal and outputs the electric signal. That is, the optical image of a subject is formed on an optical surface of the DVC CCD 115 by the DVC lens 111, and the DVC CCD 115 converts the optical image formed on a photo sensitive surface into an electric signal, performs horizontal and vertical scanning on the electric signal and outputs it in the form of an one-dimensional electric signal.

The DVC CDS/AGC/ADC 117 removes noise from the output signal from the DVC CCD 115 by using the Correlated Double Sampling circuit (CDS), and adjusts a gain by using the Auto Gain Controlling circuit (AGC) to keep the signal's level constant, and converts the output signal to a digital signal by using the A/D Converter.

The DVC signal processing unit 120 processes the digital signal applied from the DVC photographing block 110, and applies the processed signal to the signal processing unit 160. More specifically, the DVC signal processing unit 120 separates the applied digital signal into a luminance (Y) signal and a chrominance (C) signal, performs gain control, image enhancement and Auto White Balance (AWB), and changes the resolution. Also, the DVD signal processing unit 120 processes sound signal generated by the audio unit 150.

The audio unit 150 receives surrounding sounds, and generates the sound signals corresponding to the image signals generated by the DVC photographing block 110 and the DSC photographing block 130.

The signal processing unit 160 applies the image signal and the sound signal which are processed by the DVC signal processing unit 120 to the display block 170. Here, when the signal processing unit 160 receives from the control block 210, a ‘photograph command’, which the user input into the operation unit 220, the signal processing unit 160 compresses the output signal from the DVC signal processing unit 120 to a Digital Video signal.

Also, the signal processing unit 160 under the control of the control block 210 sends the compressed signals for recording to a VCR block 180.

Alternatively, if the composition photographing apparatus is operated in ‘VCR play’ mode, the image signal processing unit 160 under the control of the control block 210 receives the compressed image and sound signals to be reproduced from the VCR block 180. And, the signal processing unit 160 expands the received compressed image signals and applies them to the display block 170.

The DSC photographing block 130 photoelectrically converts a light signal that passes through the lens into an electric signal, and performs a designated signal process on the converted signal. The DSC photographing block 130 can photograph both moving images and still images. However, moving images photographed by the DSC photographing block 130, typically, comprises more data than that of moving images photographed by the DVC photographing block 110. This means that a greater amount of storage is required to record the moving image data in the recording medium, so it is not practical to photograph moving images for an extended period of time. Therefore, the DSC photographing block 130 is mainly used for photographing still images.

The DSC photographing block 130 comprises a DSC lens 131, a DVC lens driving unit 133, a DSC Charge Coupled Device (CCD) 135, and a Correlated Double Sampler/Auto Gain Controller/Analog-to-Digital converter (DSC CDS/AGC/ADC) 137.

The DSC lens driving unit 133 under the control of the control block 210 drives the DSC lens 131. More specifically, the DSC lens driving unit 133 under the control of the control block 210 zooms in and out the DSC lens 131, automatically focuses, and adjusts the aperture size of a diaphragm (not shown) of the DSC lens 131. Here, the DSC lens is zoomed in to photograph a subject close up, and is zoomed out to photograph the subject as it is.

The DSC CCD 135 converts an optical image that passes through the DSC lens 131 to an electric signal, and outputs the converted signal.

The DSC CDS/AGC/ADC 137 removes noises from the signal output from the DSC CCD 135 by using the CDS, adjusts a gain by using the AGC to keep the signal's level to be constant, and converts the output signal to a digital signal by using the ADC.

The DSC signal processing unit 140 performs a designated signal process on the signal output from the DSC photographing block 130. More specifically, the DSC signal processing unit 140 separates the signal output from the DSC photographing block 140 into a luminance (Y) signal and a chrominance (C) signal, and is involved in gain control, image enhancement and Auto White Balance (AWB), and changes the resolution. Also, the DSC signal processing unit 140 processes the sound signal generated by the audio unit 150.

The DSC CODEC 145 applies the image signal and the sound signal processed by the DSC signal processing unit 140 to the display block 170 via the system bus 240.

When the DSC CODEC 145 receives a ‘photograph command’ that the user input to the operation unit 220, it compresses the output signal from the DSC signal processing unit 140 into a JPEG-formatted signal. Also, the DSC CODEC 145 under the control of the control block 210 records the compressed signal in the memory card 190 via the system bus 240.

Meanwhile, if the composition photographing apparatus is operating in ‘memory card reproduce’ mode, the DSC CODEC 145 under the control of the control block 210 receives from the memory card 190 the compressed image and sound signals to be reproduced. And, the DSC CODEC 145 expands the compressed image and sound signals and applies them to the display block 170.

The display block 170 displays output image signals from the signal processing unit 160 and the DSC CODEC 145, and outputs the sound signal. The display block 170 includes On Screen Display (OSD) 171, a National Television System Committee/Phase Alternation line (NTSC/PAL) encoder 173, and Liquid Crystal Display (LCD) 175.

The OSD unit 171 stores OSD characters and Graphic User Interface (GUI) data, like a menu screen, required for constructing GUI environment. The OSD unit 171 under the control of the control block 210 combines output images from the signal processing unit 160 and the DSC CODEC 145 with the OSD characters or GUI data.

The NTSC/PAL encoder 173 converts the image signals output from the OSD unit 171 to NTSC signals or PAL signals, and applies them to an external device, such as a television or the like. The LCD 175 displays the images applied from the NTSC/PAL encoder 241.

The VCR block 180 records image signals output from the signal processing unit 160, or reads the image signals being recorded to apply them to the signal processing unit 160. The VCR block 180 comprises a VCR deck 181 and a VCR tape 183.

The VCR tape 183 is a magnetic recording medium recording image and sound signals, and is detachable from the VCR deck 181.

The VCR deck 181 records image and sound signals applied from the signal processing unit 160 in the VCR tape 183, or reads the image signals recorded in the VCR tape 183 to apply them to the signal processing unit 160.

The memory card 190 is preferably a recording medium for recording image signals and sound signal applied from the DSC CODEC 145, and is detachable from the composition photographing apparatus.

The PC interface 200 interfaces with an external device, such as a PC or a printer.

The control block 210 controls the general operations of the composition photographing apparatus, according to the user-input operation commands through the operation unit 220. Particularly, the control block 210 controls the DVC photographing block 110 or the DSC photographing block 130 to take photographs in response to a command input by the user. The control block 210 comprises a main control unit 211, a MUX 245, an Audio CODEC 250, and a DSC control unit 213.

The main control unit 211 receives an operation command that the user input into the operation block 220, and controls the operations of the DVC lens driving unit 113, the DVC signal processing unit 120, the signal processing unit 160, the OSD unit 171, the VCR deck 181, and the PC interface 200. Also, the main control unit 211 controls the operation of the DSC control unit 312.

The DSC control unit 213, under the control of the main control unit 211, controls the operations of the DSC lens driving unit 133, the DSC signal processing unit 140, and the DSC CODEC 145.

The flash memory 230 preferably stores therein a system program for use in the operation of the apparatus, such as a booting program, needed by the main control unit 230, other important data, which has to be saved even after the power is turned off, and application.

The operation unit 220 is a user interface for receiving, from the user, operation commands associated with the selection of a function and the operational control of the composition photographing apparatus.

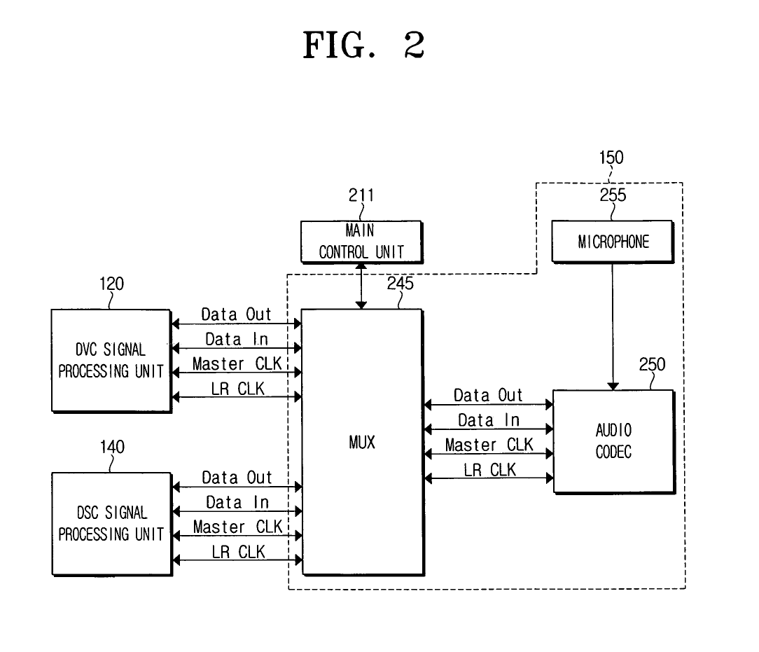

FIG. 2 is a diagram of the audio unit of FIG. 1. As shown in FIG. 2, the audio unit 150 includes a MUX 245, an Audio CODEC 250, and a microphone 255.

The DVC signal processing unit 120 and the DSC signal processing unit 140, each performs a designated signal processing on the moving image signals photographed by the DVC photographing block 110 and the DSC photographing block 130, respectively. The processed moving image signals are transferred to the MUX 245. At this time, the DVC signal processing unit 120 and the DSC signal processing unit 140, respectively, transfer the master CLK for the synchronization with the Audio CODEC 250.

The MUX 245 multiplexes the moving image signals received from the DVC signal processing unit 120 and the DSC signal processing unit 140, and transfers the multiplexed moving image signal to the Audio CODEC 250. The multiplexing process of the MUX 245 is controlled by the main control unit 211.

The Audio CODEC 250 receives electric signals from the audio unit 150 and codes the received electric signals and combines them with the moving image signals multiplexed by the MUX 245. The DSC and the DVC, respectively, output a master CLK for frequency synchronization with the Audio CODEC 250. On the basis of the master CLK received from the DVC or the DSC through the MUX 245, the Audio CODEC 250 samples the coded audio signals and combines them with the multiplexed moving image signals. The Audio CODEC 250 samples the coded audio signals preferably within a range of 8 kHz to 60 kHz, to be synchronized, not only with moving image signals received from the DSC, but also with the moving image signals received from the DVC. For example, suppose that the Audio CODEC 250 received a moving image signal from the DVC signal processing unit 120 through the MUX 245. Then the Audio CODEC 250 samples the audio signals received from the microphone 255 at 32 kHz, 48 kHz and the like. Conversely, when the Audio CODEC 250 receives a moving image signal from the DSC signal processing unit 140 through the MUX 245, it samples the audio signals received from the microphone 255 at 8 kHz. Moreover, the Audio CODEC 250 combines the audio signal samples with the moving image signals received through the MUX 245, and records the audio signals.

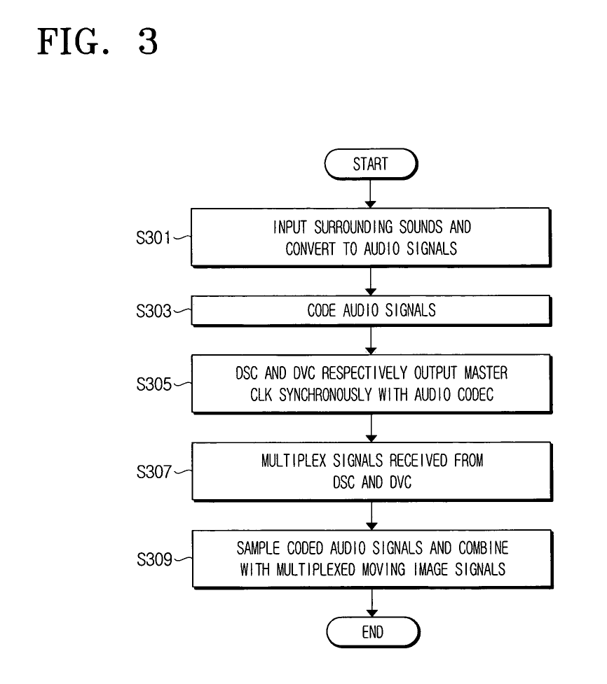

FIG. 3 is a flow chart describing a sound recording method of FIG. 2. Referring to FIG. 3, the microphone 255 inputs surrounding sounds and converts them to electric audio signals (S301). The electric signals converted from audio signals by the microphone 255 are then transferred to the Audio CODEC 250.

The Audio CODEC 250 codes the electric signals received from the microphone 255 (S303).

The DVC signal processing unit 120 and the DSC signal processing unit 140, respectively, transfer to the MUX 245 their photographed moving image signals together with the master CLK for the synchronization with the Audio CODED 250.

The MUX 245, under the control of the main control unit 111, multiplexes the moving image signals received from the DVC signal processing unit 120 and the DSC signal processing unit 140, respectively, and transfers the multiplexed signals to the Audio CODEC 250.

The Audio CODEC 250 receives the moving image signals multiplexed by the MUX 245, samples the electric signals based on the master CLK sent together with the received moving image signals, and combines the electric signal samples with the received moving signals (S309).

Therefore, the composition photographing apparatus is capable of synchronizing the moving image signals photographed by the DVC photographing block 110 and the DSC photographing block 130 through one integrated Audio CODEC 250.

In short, the composition photographing apparatus of the present invention can be advantageously used for reducing the cost of manufacturing the apparatus, improving the efficiency of sound recording and, reducing the total volume of the composition photographing apparatus. Because of the reduced apparatus volume, the user can more conveniently carry around the composition photographing apparatus.

While the invention has been shown and described with reference to a certain preferred embodiment thereof, it will be understood by those skilled in the art that various changes in form and details may be made therein without departing from the spirit and scope of the invention as defined by the appended claims.

1. A Digital Still Camera (DSC) and Digital Video Camera (DVC) composition photographing apparatus, comprising:
a multiplexer (MUX) connected to the DSC and the DVC, respectively, for multiplexing moving image signals received from the DSC and the DVC, respectively;
an Audio coder/decoder (CODEC) for coding audio signals and combining the coded audio signals with the moving image signals multiplexed by the MUX; and
a control unit for controlling the multiplexing process by the MUX.

2. The composition photographing apparatus according to claim 1, further comprising:
a microphone for inputting surrounding sounds and converting the sounds to electric audio signals.

3. The composition photographing apparatus according to claim 1, wherein the DSC and the DVC, respectively, output a master CLK for the synchronization with the Audio CODEC, and the Audio CODEC samples the coded audio signals based on the master CLK received through the MUX and combines the audio signal samples with the moving image signals multiplexed by the MUX.

4. The composition photographing apparatus according to claim 3, wherein the Audio CODEC samples the coded audio signals within a frequency range of 8 kHz to 60 kHz.

5. A sound recording method of a DSC and DVC composition photographing apparatus, the method comprising the steps of:
inputting surrounding sounds and converting the sounds to electric audio signals;
multiplexing moving image signals received from the DSC and the DVC, respectively;
coding the converted audio signals; and
sampling the coded audio signals and combining the audio signal samples with the multiplexed moving image signals.

6. The method according to claim 5 further comprising the step of:
outputting a master CLK from the DSC and the DVC for the synchronization with an Audio CODEC, respectively, wherein the Audio CODEC samples the coded audio signals based on the master CLK and combines the audio signal samples with the moving image signals.

7. The method according to claim 6, further comprising the steps of:
outputting the combined audio signal and moving images signals to at least one of a storage device, and an output device.
